(19) United States
(12) Patent Application Publication
(10) Pub. No.: US 2018/0219871 A1
(43) Pub. Date: Aug. 2, 2018

(54) VERIFICATION OF FRAGMENTED INFORMATION CENTRIC NETWORK CHUNKS

(71) Applicant: Futurewei Technologies, Inc., Plano, TX (US)

(72) Inventors: Syed Obaid Amin, Santa Clara, CA (US); Qingji Zheng, Sunnyvale, CA (US); Ravishankar Ravindran, San Ramon, CA (US)

(21) Appl. No.: 15/422,004

(22) Filed: Feb. 1, 2017

(51) Int. Cl. H04L 29/06; G06F 21/64

(52) U.S. Cl. CPC H04L 63/123; G06F 21/64

(57) ABSTRACT

Methods, apparatus, and systems are provided for lightweight integrity verification of fragmented chunks in an information centric network. One aspect provides a method of securely providing data. A data file is segmented into multiple chunks of data, and each of the multiple chunks is divided into virtual fragments based on a maximum transmission unit size. Hash values are calculated using the virtual fragments, and a manifest is created using the hash values. In various embodiments, the manifest is provided to a consumer based on a received interest for comparison and integrity verification of virtual fragments.

### TECHNICAL FIELD

The present disclosure relates to information centric networking (ICN), such as content centric networking (CCN), and in particular to lightweight integrity verification of fragmented chunks in an ICN or CCN network.

### BACKGROUND

Internet Protocol (IP) forwarding is based on host-to-host communication utilizing host addresses. Communications are assumed to take place between two static end points. IP forwarding is sender-oriented, i.e., the receiver has no control of specifying the properties related to the information it desires, for example, content version, publisher, etc. Considering the growth in user driven multimedia content today, content distribution network (CDN) has been developed to support content distribution. However, CDN is a technology overlaid over IP and is application specific.

As an alternative approach, information centric networking (ICN), such as content centric networking (CCN), addresses these issues by shifting the communication paradigm from a host-centric to a content-centric model. User requests are translated into packet data units that contain the name of the information sought with associated metadata. A router, upon receiving such a query, resolves it to itself if it has a cached copy of the data or forwards it along the direction where the content can be obtained.

### SUMMARY

Methods, apparatus, and systems are provided for lightweight integrity verification of fragmented chunks in an information centric network. Various examples are now described to introduce a selection of concepts in a simplified form that are further described below in the detailed description. The Summary is not intended to identify key or essential features of the claimed subject matter, nor is it intended to be used to limit the scope of the claimed subject matter.

In example 1, a method of securely providing data from a producer includes segmenting a data file into multiple chunks of data using a processor of the producer, and dividing each of the multiple chunks into virtual fragments based on a maximum transmission unit size using the processor. Using the processor, hash values are calculated using the virtual fragments, and a manifest is created using the hash values. Using the processor, the manifest is provided to a consumer based on a received interest for comparison and integrity verification of virtual fragments.

In example 2, the method also includes adding the hashes to a manifest file accessible to the consumer. In example 3, calculating hash values includes using a bloom filter for each of the multiple chunks. In example 4, using a bloom filter includes passing the virtual fragments to one or more hash functions, where the bloom filter represents the hash value of a corresponding chunk. In example 5, hash values are provided to an information centric network router for comparison and integrity verification of virtual fragments, in an embodiment. A size of a chunk is a multiple of a size of the virtual fragment, in example 6. The last chunk may be smaller than the size of the virtual fragment, in an embodiment. Each virtual fragment includes data from a single chunk, in example 7.

Example 8 provides a method implemented by an information centric network router. The method includes using a processor of the router to receive an interest for a data file segment from a consumer, and to send the interest to a content producer. A fragment of the data file segment is received from the producer in response to the interest, along with a fragment header, and the fragment is divided into virtual fragments based on a maximum transmission unit size. A hash value of the virtual fragment is compared to the fragment header to verify the integrity of the virtual fragment, and the virtual fragment is stored if the integrity was verified, in various embodiments.

In example 9, comparing a hash value of the virtual fragment to the fragment header to verify the integrity of the virtual fragment includes comparing the virtual fragment on a hop-by-hop basis. The method further includes assembling a chunk using the stored virtual fragments, in example 10, and forwarding the chunk to the consumer after assembling the chunk, in example 11. In example 12, the method includes dividing the fragment into virtual fragments using a bloom filter.

Example 13 provides a network enabled computer system including a processor and a storage device coupled to the processor. The storage device includes instructions to cause the processor to execute operations including segmenting a data file into multiple chunks of data, and dividing each of the multiple chunks into virtual fragments based on a maximum transmission unit size. Hash values are calculated using the virtual fragments, and a manifest is created using the hash values. The manifest is provided for use by consumer for comparison and integrity verification of virtual fragments, in various embodiments.

In example 14, calculating hash values using the virtual fragments includes calculating hash values on a hop-by-hop basis. The storage device includes instructions to cause the processor to add the hashes to a manifest file accessible to the consumer, in example 15. In example 16, the storage device includes instructions to cause the processor to calculate hash values includes using a bloom filter for each of the multiple chunks. In example 17, the storage device includes instructions to cause the processor to pass the virtual fragments to one or more hash functions, where the bloom filter represents the hash value of a corresponding chunk. The storage device includes instructions to cause the processor to provide hash values to an information centric network router for comparison and integrity verification of virtual fragments, in example 18. In example 19, a size of a chunk is a multiple of a size of the virtual fragment. Each virtual fragment includes data from a single chunk, in example 20.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 is a block diagram illustrating segmentation of data in an information centric network, according to various embodiments.

FIGS. 2A-2B are flow diagrams illustrating a method for a producer of data to create a manifest file in an information centric network, according to various embodiments.

FIG. 3A is a flow diagram illustrating a method for an intermediate router to process a received interest in an information centric network, according to various embodiments.

FIGS. 3B-3C are flow diagrams illustrating methods for an intermediate router to verify integrity of fragmented chunks in an information centric network, according to various embodiments.

FIG. 4 is a block diagram illustrating assembly of fragments from virtual fragments in an information centric network, according to various embodiments.

FIG. 5 is a block diagram illustrating an example of calculation of hash values of a chunk of data in an information centric network, according to various embodiments.

FIGS. 6A-6B are block diagrams illustrating verification of integrity of a chunk of data in an information centric network, according to various embodiments.

FIG. 7A is a block diagram illustrating hash calculation using virtual fragments in an information centric network, according to various embodiments.

FIG. 7B is a block diagram illustrating verification of integrity of a chunk of data in an information centric network using virtual fragments, according to various embodiments.

FIG. 8 is a diagram illustrating circuitry for implementing devices to perform methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

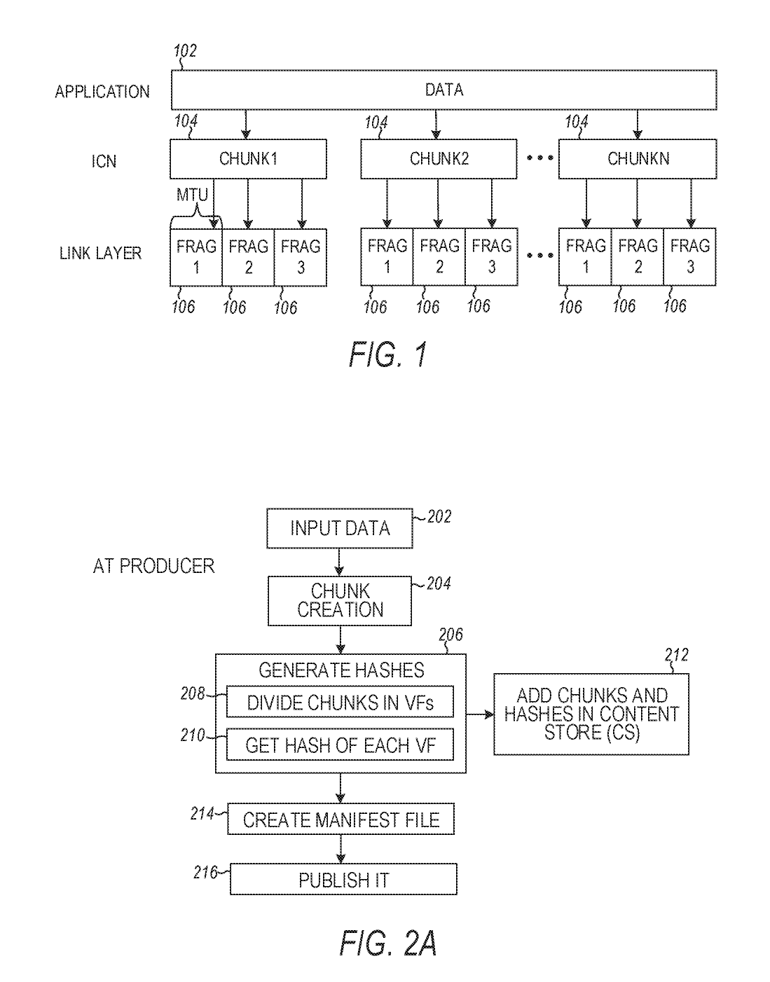

Information centric networking (ICN), such as content centric networking (CCN), shifts the communication paradigm from a host-centric to a content-centric model. User (or consumer) requests are translated into packet data units that contain the name of the information sought with associated metadata. A router, upon receiving such a query (or interest), resolves it to itself if it has a cached copy of the data or forwards it along the direction where the content can be obtained (the producer). The data is handled in segments called chunks. Chunks are created by segmentation of a data file, followed by calculation of hashes for the chunks, and publication of a manifest based on the hashes, according to various embodiments. A consumer fetches the manifest file, gets the hashes available in a chunk file, and requests data based on their hashes. FIG. 1 illustrates data 102 from an application that is divided into chunks 104 in an ICN network, and that is further divided into fragments 106 in a link layer.

Fragmentation is used for chunks that are larger than a maximum transmission unit (MTU). Two types of fragmentation may be used, end-to-end fragmentation or hop-by-hop fragmentation. End-to-end fragmentation includes producer fragmentation of chunked data according to the MTU carried by the including interest. Hop-by-hop fragmentation includes re-fragmenting chunked data at each intermediate router.

The data is forwarded using forwarding rules, including hop-by-hop with assembly or cut-through switching. In hop-by-hop with assembly, the intermediate routers assemble all frames, check chunk integrity using hash values, and then fragment the chunk before forwarding. In cut-through switching, the intermediate routers forward the packets as soon as they are received, and reassembly is done at the end or host. Currently in ICN or CCN, if a chunk of data is corrupted, it may waste resources of the intermediate routers. An improved method and apparatus to verify integrity of fragmented chunks in an information centric network is needed.

The present subject matter provides verification of fragmented chunks to identify chunk corruption closer to the provider or producer, using a lightweight algorithm to preserve network resources. An improved method to create chunk hashes (referred to as contentObjectHash) is included that provides for rapid detection of corrupted chunks, in various embodiments. Thus, the present subject matter reduces the chances of distributed denial of service (DDoS) attacks from packet reassembly.

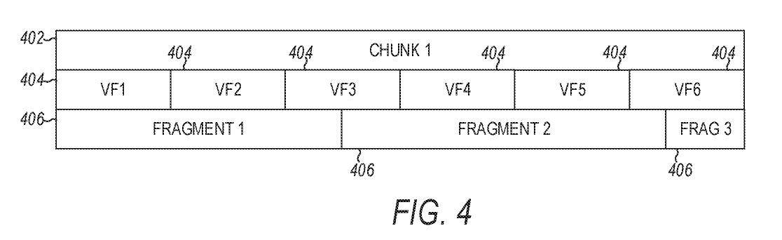

One aspect provides a method for a producer of data to create a manifest file, as shown in FIG. 2B, for example. A data file is segmented into multiple chunks of data 220, and each of the multiple chunks is divided into virtual fragments (as shown in FIG. 4) based on a maximum transmission unit size 222. Hash values are calculated using the virtual fragments 224, and a manifest is created using the hash values 226. In various embodiments, the manifest is provided to a consumer based on a received interest for comparison and integrity verification of virtual fragments 228.

In various embodiments, the method also includes adding the hashes to a manifest file accessible to the consumer. In one embodiment, calculating hash values includes using a bloom filter for each of the virtual fragments. Various embodiments include passing the virtual fragments to one or more hash functions, where the bloom filter represents the hash value of a corresponding chunk. The present subject matter provides a novel method of creating a manifest, or metadata file, using the hash values of virtual fragments. The manifest is provided to a consumer based on a received interest, in an embodiment. A size of a chunk is a multiple of a size of the virtual fragment, in various embodiments. Each virtual fragment includes data from a single chunk, in an embodiment.

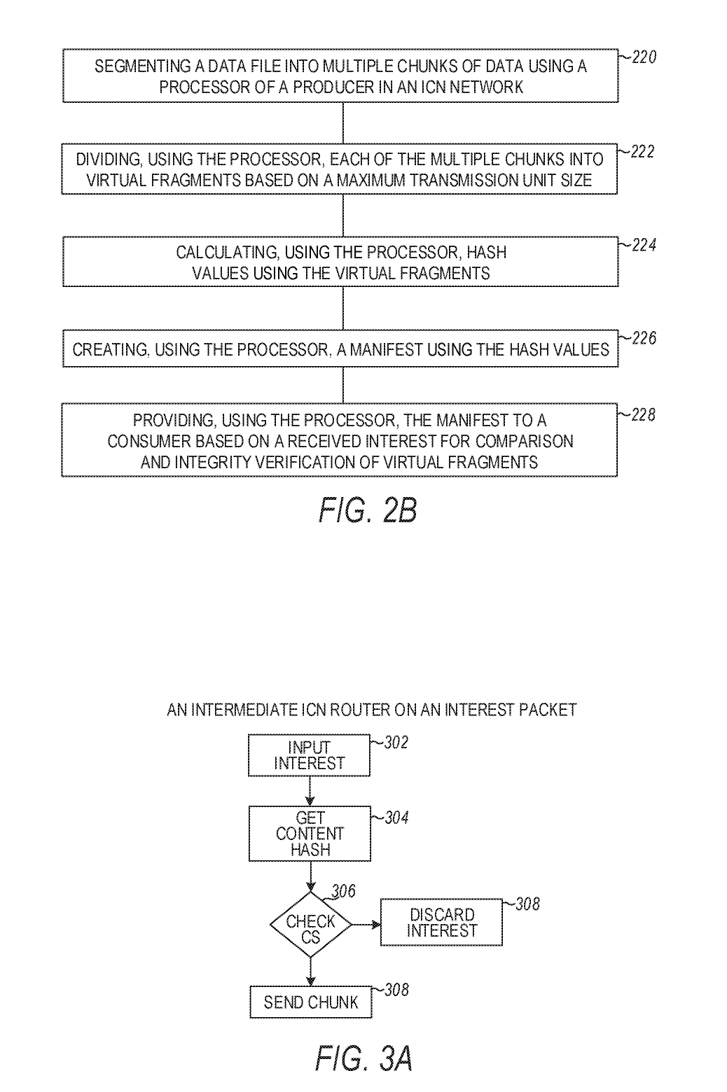

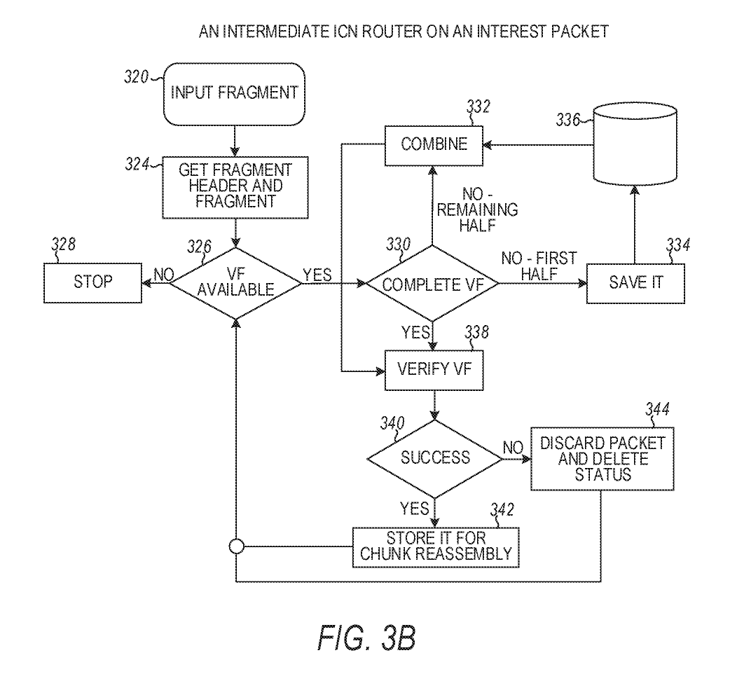

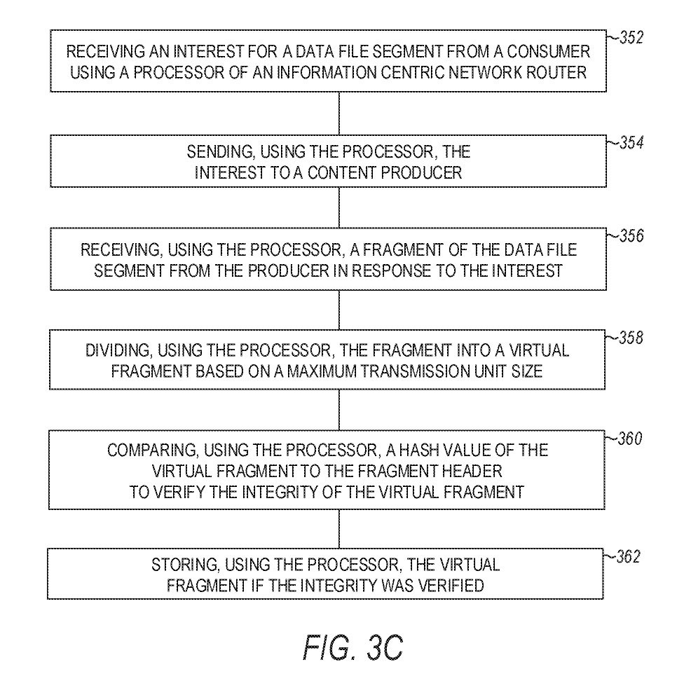

Another aspect provides a method implemented by an information centric network router, as shown in FIG. 3C, for example. The method includes receiving an interest for a data file segment from a consumer 352, and sending the interest to a content producer 354. A fragment of the data file segment is received from the producer in response to the interest 356, along with a fragment header, and the fragment is divided into virtual fragments based on a maximum transmission unit size 358. A hash value of the virtual fragment is compared to the fragment header to verify the integrity of the virtual fragment 360, and the virtual fragment is stored if the integrity was verified 362, in various embodiments.

According to various embodiments, comparing a hash value of the virtual fragment to the fragment header to verify the integrity of the virtual fragment includes comparing the virtual fragment on a hop-by-hop basis. The method further includes assembling a chunk using the stored virtual fragments, in an embodiment, and forwarding the chunk to the consumer after assembling the chunk. Various embodiments include dividing the fragment into virtual fragments using a bloom filter.

A further aspect provides a network enabled computer system including a processor and a storage device coupled to the processor. The storage device includes instructions to cause the processor to execute operations including segmenting a data file into multiple chunks of data, and dividing each of the multiple chunks into virtual fragments based on a maximum transmission unit size. Hash values are calculated using the virtual fragments, and a manifest is created using the hash values. Hash values are provided for use by an information centric network router for comparison and integrity verification of virtual fragments, in various embodiments.

According to various embodiments, calculating hash values using the virtual fragments includes calculating hash values on a hop-by-hop basis. The storage device includes instructions to cause the processor to add the hashes to a manifest file accessible to the consumer, in various embodiments. According to various embodiments, the storage device includes instructions to cause the processor to calculate hash values includes using a bloom filter for each of the virtual fragments, and to cause the processor to pass the virtual fragments to one or more hash functions, where the bloom filter represents the hash value of a corresponding chunk. The storage device includes instructions to cause the processor to provide the manifest to a consumer based on a received interest, in an embodiment. In one embodiment, a size of a chunk is a multiple of a size of the virtual fragment. Each virtual fragment includes data from a single chunk, in an embodiment.

FIG. 2A is a flow diagram illustrating a method for a producer of data to create a manifest file in an information centric network, according to various embodiments. The producer creates chunks 202 from input data 204, and generates hashes 206. In various embodiments, generating hashes includes dividing the chunks into virtual fragments (VF) 208 and calculating hashes of each virtual fragment 210. Chunks and hashes are added to a content store (CS), and a manifest file is created 214 and published 216, in various embodiments. In various embodiments, the manifest file is stored in the content store. In other embodiments, the manifest file is stored in a storage location that is not in the content store.

FIG. 3A is a flow diagram illustrating a method for an intermediate router to process a received interest in an information centric network, according to various embodiments. In FIG. 3A, when an intermediate ICN router receives an interest packet 302, the router obtains a content hash 304 and checks the hash against the content store 306. If there is a match 310, the chunk is forwarded, but if no match is found, the interest is discarded.

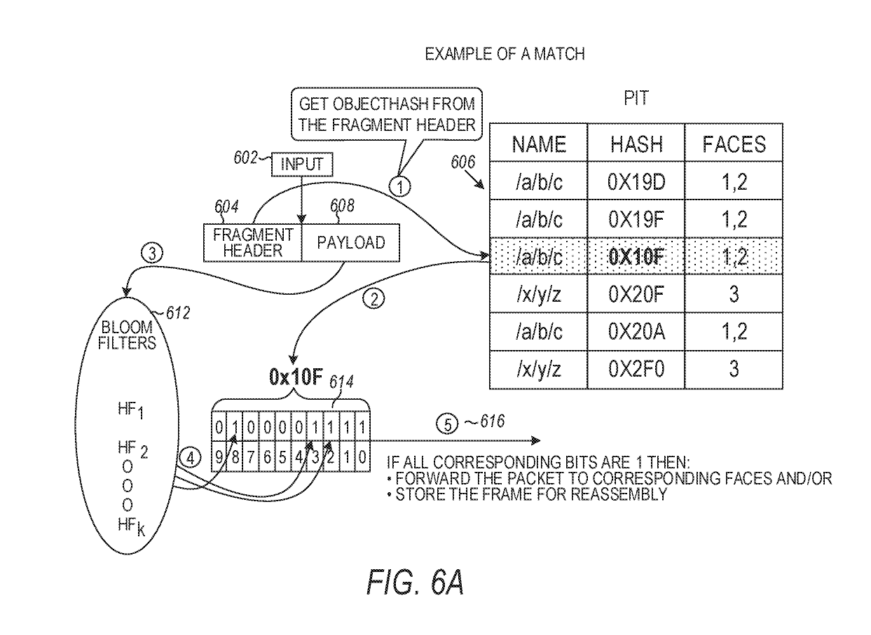

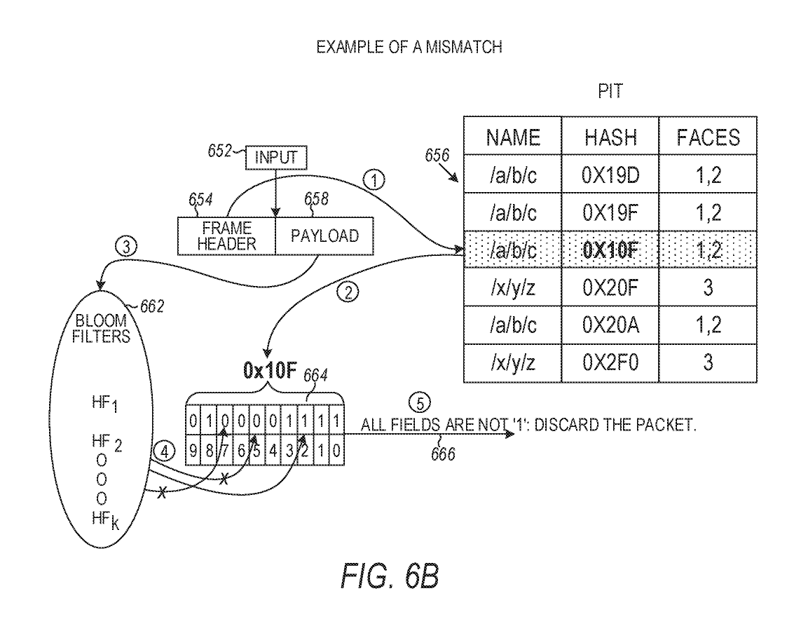

FIG. 3B is a flow diagram illustrating a method for an intermediate router to verify integrity of fragmented chunks in an information centric network, according to various embodiments. In FIG. 3B, when an intermediate ICN router receives a data packet or fragment 320, the router obtains the fragment header and fragment 324 and checks if a virtual fragment is available 326. If the virtual fragment is not available 328, the process is halted. If the virtual fragment is available, the ICN router looks for a complete virtual fragment 330. If a complete virtual fragment is not available, the ICN router will save the first half of the virtual fragment 334 in a content store 336, and combine the first half with the remaining portion of the virtual fragment 332 when received. If a complete virtual fragment has been received, the virtual fragment is verified 338 using the process as shown in FIGS. 6A-6B. If the verification process 340 is successful 342, the chunk is stored for reassembly 342. If the verification process 340 is not successful 344, the packet is discarded by the ICN router and the states are deleted, in various embodiments.

FIG. 4 is a block diagram illustrating assembly of fragments from virtual fragments in an information centric network, according to various embodiments. A representative chunk 402, referred to as chunk 1, is divided into virtual fragments 404 of size of the MTU. Fragments 406 received by an ICN router are shown to include multiple virtual fragments in the depicted embodiment, which includes chunks of 9 kB, virtual fragments of 1.5 kB, and fragments of 4 kB. Other sizes of chunks, virtual fragments and fragments can be used without departing from the scope of the present subject matter. In various embodiments, each received portion is assumed to be of the length of the MTU, besides the last received segment which may be less than the MTU.

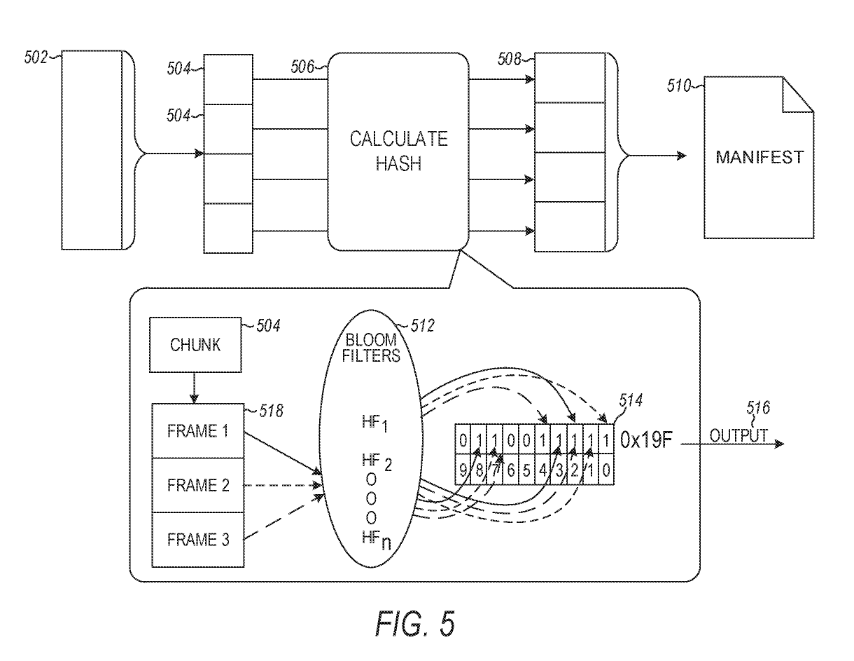

FIG. 5 is a block diagram illustrating an example of calculation of hash values of a chunk 504 of data 502 in an information centric network, according to various embodiments. The hash calculation 506 of the present subject matter includes using frames 518 or virtual fragments of chunks 504 and applying a bloom filter 512 for each to obtain calculated hash values 514 that are compared to stored hash values 508 published in manifest 510, and providing an output 516 based on the comparison, in various embodiments. A bloom filter is a probabilistic data structure used to test whether an element is a member of a set.

FIGS. 6A-6B are block diagram illustrating verification of integrity of a chunk of data in an information centric network, according to various embodiments. FIG. 6A illustrates a match being made by an intermediate ICN router, in an embodiment. An input 602 is received that includes a payload 608 and a fragment header 604. The ObjectHash (hash value of actual object) is included as part of the fragment header 604 to be used for verification, in various embodiments. The ICN router obtains the ObjectHash from the pending interest table (PIT) 606, and further uses payload 604 of input 602 to calculate hashes 614 using bloom filters 612 for available virtual fragments, in an embodiment. Since the calculated hash value (0x10F in the depicted embodiment) matches the received hash value (Object Hash), the verification is a match, and the ICN router checks if the corresponding output fields are set to 1 and forwards the packet to corresponding faces, and/or stores the frame for reassembly, according to various embodiments.

FIG. 6B illustrates a mismatch result for integrity verification, in an embodiment. An input 652 is received that includes a payload 658 and a fragment header 654. The ObjectHash (hash value of actual object) is included as part of the fragment header 654 to be used for verification, in various embodiments. The ICN router obtains the ObjectHash from the pending interest table (PIT) 656, and further uses payload 654 of input 652 to calculate hashes 664 using bloom filters 662 for available virtual fragments, in an embodiment. Since the calculated hash value does not matches the received hash value (Object Hash), the verification is a mismatch, and the ICN router checks the corresponding output fields 666, and discards the packet if the value is 0, according to various embodiments.

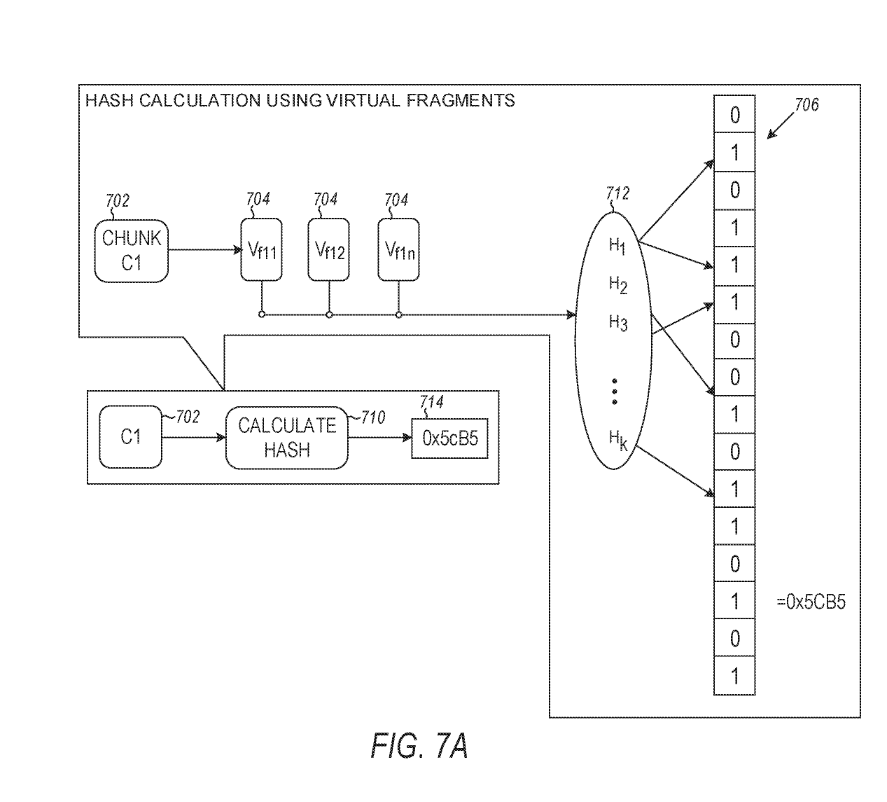

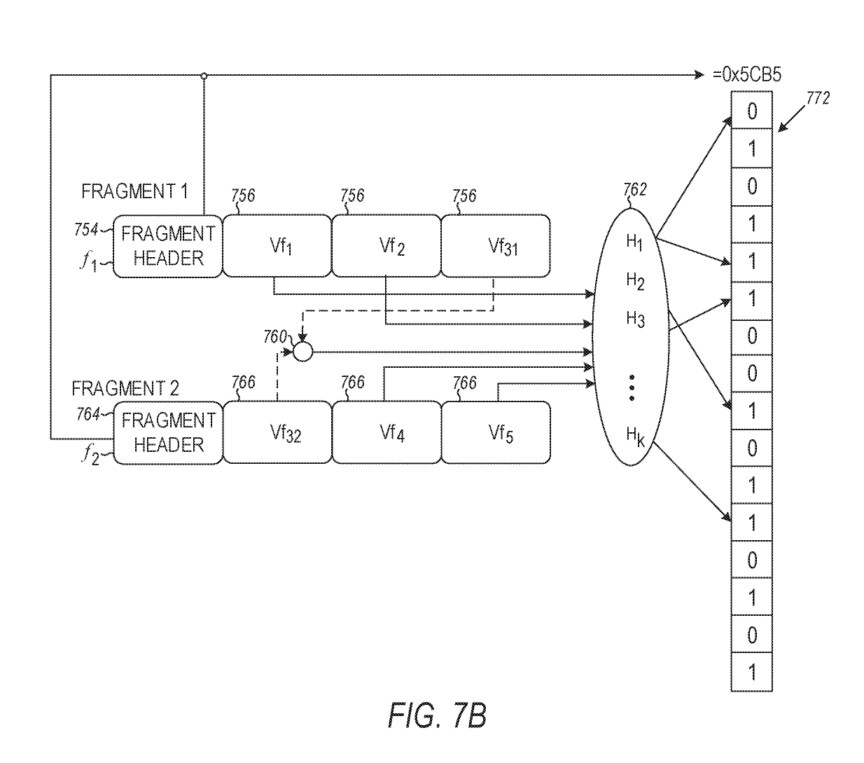

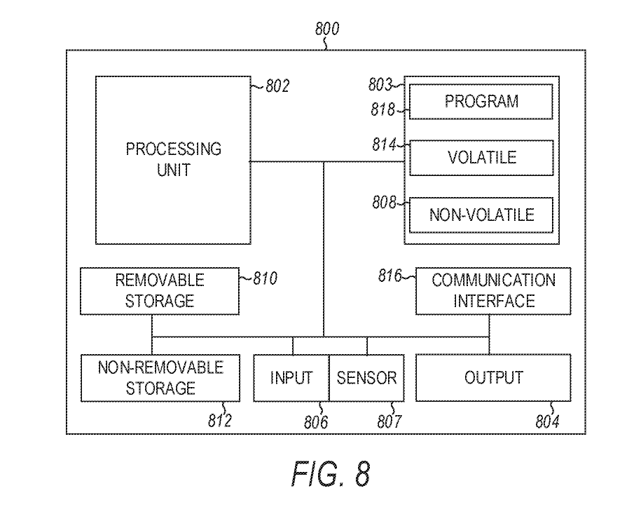

FIG. 7A is a block diagram illustrating hash calculation using virtual fragments in an information centric network, according to various embodiments. In FIG. 7A, hash value calculation 710 is used on a chunk 702 that is divided into virtual fragments 704, and bloom filters 712 are used to calculate hash values that are stored in a manifest file 706. The resulting calculated hash value 714 is used to verify a match against received hash values, as shown in FIGS. 6A-6B. FIG. 7B is a block diagram illustrating verification of integrity of a chunk of data in an information centric network using virtual fragments, illustrating the forwarding rules and processing logic used to make the data integrity verification matches, according to various embodiments. A first fragment f1 has a fragment header 754 and virtual fragments 756, and a second fragment f2 has fragment header 764 and virtual fragments 766, in an embodiment. A combination 760 of virtual fragment 756 and 766 is used with bloom filters 762 to calculate hash values stored in a manifest file 772. With respect to one embodiment of forwarding rules, for each fragment f, if N or N-1 virtual fragments can be found in the bloom filter 762, and if the not-in-sequence counter is less than a predetermined threshold, then the fragment f is forwarded by the router. If these conditions are not met, then the fragment f is dropped in an embodiment. With respect to one embodiment of processing logic, for each fragment f, if the fragment has a partial virtual fragment, it is saved until the next in-sequence fragment is received. Upon receiving the next in-sequence fragment, the remaining portion of the virtual fragment is obtained for verification. If the fragment is not in-sequence, the not-in-sequence counter is increased, in an embodiment.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

FIG. 8 is a schematic diagram illustrating circuitry for performing methods according to example embodiments. All components need not be used in various embodiments. For example, the computing devices may each use a different set of components and storage devices.

One example computing device in the form of a computer 800 may include a processing unit 802, memory 803, removable storage 810, and non-removable storage 812 coupled by a bus 820. Although the example computing device is illustrated and described as computer 800, the computing device may be in different forms in different embodiments. For example, the computing device may instead be a smartphone, a tablet, smartwatch, router, or other computing device including the same or similar elements as illustrated and described with regard to FIG. 8. Devices such as smartphones, tablets, and smartwatches are generally collectively referred to as mobile devices. Further, although the various data storage elements are illustrated as part of the computer 800, the storage may also or alternatively include cloud-based storage accessible via a network, such as the Internet or server based storage.

Memory 803 may include volatile memory 814 and/or non-volatile memory 808. Computer 800 may include—or have access to a computing environment that includes—a variety of computer-readable media, such as volatile memory 814 and/or non-volatile memory 808, removable storage 810 and/or non-removable storage 812. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Storage can also include networked storage such as a storage area network (SAN).

Computer 800 may include or have access to a computing environment that includes input 806, output 804, and a communication interface 816. In various embodiments, communication interface 816 includes a transceiver and an antenna. Output 804 may include a display device, such as a touchscreen, that also may serve as an input device. The input 806 may include one or more of a touchscreen, touchpad, mouse, keyboard, camera, one or more device-specific buttons, one or more sensors 807 integrated within or coupled via wired or wireless data connections to the computer 800, or other input devices. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions, i.e., a program 818, comprises instructions stored on a computer-readable medium that are executable by the processing unit 802 of the computer 800. The terms computer-readable medium and storage device do not include carrier waves to the extent carrier waves are deemed too transitory.

In one example, the processing unit 802 executes the program 818 to receive an interest for a data file segment from a consumer, and send the interest to a content producer. A fragment of the data file segment is received from the producer in response to the interest, and the fragment is divided into virtual fragments based on a maximum transmission unit size. The virtual fragment is compared to a manifest to verify the integrity of the virtual fragment, and the virtual fragment is stored if the integrity was verified, in various embodiments.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method of verifying data from a producer, the method comprising:
segmenting a data file into multiple chunks of data using a processor of the producer;
dividing, using the processor, each of the multiple chunks into virtual fragments based on a maximum transmission unit size;
calculating, using the processor, hash values using the virtual fragments;
creating, using the processor, a manifest using the hash values; and
providing, using the processor, the manifest to a consumer based on a received interest for comparison and integrity verification of virtual fragments.

2. The method of claim 1, further comprising adding the hashes to a manifest file accessible to the consumer.

3. The method of claim 1, wherein calculating hash values includes using a bloom filter for each of the virtual fragments.

4. The method of claim 3, using a bloom filter includes passing the virtual fragments to one or more hash functions, wherein the bloom filter represents the hash value of a corresponding chunk.

5. The method of claim 1, further comprising providing hash values to an information centric network router for comparison and integrity verification of virtual fragments.

6. The method of claim 1, wherein a size of a chunk is a multiple of a size of the virtual fragment, except for the last chunk.

7. The method of claim 1, wherein each virtual fragment includes data from a single chunk.

8. A method implemented by an information centric network router, the method comprising:
receiving an interest for a data file segment from a consumer using a processor of the information centric network router;
sending, using the processor, the interest to a content producer;
receiving, using the processor, a fragment of the data file segment from the producer in response to the interest, along with a fragment header;
dividing, using the processor, the fragment into a virtual fragment based on a maximum transmission unit size;
comparing, using the processor, a hash value of the virtual fragment to the fragment header to verify the integrity of the virtual fragment; and
storing, using a storage device coupled to the processor, the virtual fragment if the integrity was verified.

9. The method of claim 8, wherein the comparing a hash value of the virtual fragment to a fragment header to verify the integrity of the virtual fragment includes comparing the virtual fragment on a hop-by-hop basis.

10. The method of claim 8, further comprising assembling a chunk using the stored virtual fragments.

11. The method of claim 10, further comprising forwarding the chunk to the consumer after assembling the chunk.

12. The method of claim 8, wherein dividing the fragment into virtual fragments includes using a bloom filter.

13. A network enabled computer system, comprising:
a processor; and
a storage device coupled to the processor, the storage device including instructions to cause the processor to execute operations comprising:
segmenting a data file into multiple chunks of data;
dividing each of the multiple chunks into virtual fragments based on a maximum transmission unit size;
calculating hash values using the virtual fragments;
creating a manifest using the hash values; and
providing the manifest to a consumer based on a received interest for comparison and integrity verification of virtual fragments.

14. The system of claim 13, wherein calculating hash values using the virtual fragments includes calculating hash values on a hop-by-hop basis.

15. The system of claim 13, wherein the storage device includes instructions to cause the processor to add the hashes to a manifest file accessible to the consumer.

16. The system of claim 13, wherein the storage device includes instructions to cause the processor to calculate hash values includes using a bloom filter for each of the virtual fragments.

17. The system of claim 16, wherein the storage device includes instructions to cause the processor to pass the virtual fragments to one or more hash functions, wherein the bloom filter represents the hash value of a corresponding chunk.

18. The system of claim 13, wherein the storage device includes instructions to cause the processor to provide hash values to an information centric network router for comparison and integrity verification of virtual fragments.

19. The system of claim 13, wherein a size of a chunk is a multiple of a size of one of the virtual fragments, except for the last chunk.

20. The system of claim 13, wherein each virtual fragment includes data from a single chunk.
